(19) United States
(12) Patent Application Publication
(10) Pub. No.: US 2025/0351193 A1
(43) Pub. Date: Nov. 13, 2025

(54) METHOD, DEVICE, AND SYSTEM FOR RADIO RESOURCE CONFIGURATION

(71) Applicant: ZTE Corporation, Shenzhen (CN)

(72) Inventors: Xiubin SHA, Shenzhen (CN); Bo DAI, Shenzhen (CN); Yuan GAO, Shenzhen (CN)

(73) Assignee: ZTE Corporation, Shenzhen (CN)

(21) Appl. No.: 19/276,702

(22) Filed: Jul. 22, 2025

Related U.S. Application Data
(63) Continuation of application No. PCT/CN2023/093788, filed on May 12, 2023.

(51) Int. Cl. H04W 74/0833; H04W 28/06; H04W 72/0453; H04W 72/12; H04W 72/231

(52) U.S. Cl. CPC H04W 74/0833; H04W 28/06; H04W 72/0453; H04W 72/12; H04W 72/231

(57) ABSTRACT

This disclosure relates generally to a method, device, and system for random access. One method performed by a wireless device may include: initiating a random access procedure with a wireless communication node; receiving control information carrying scheduling information for reception of a message carrying contention resolution information, the scheduling information indicating a frequency domain resource allocated to the message, and the contention resolution information indicating whether a contention resolution associated with the random access procedure is successful; and in response to one of: the frequency domain resource allocated to the message being larger than a threshold; or the message being unable to be decoded successfully, performing at least one of: considering the contention resolution to be unsuccessful; stopping a contention resolution timer associate with the random access procedure; discarding a temporary C-RNTI assigned by the wireless communication node for the random access procedure; or triggering another random access procedure.

### TECHNICAL FIELD

This disclosure is directed generally to wireless communications, and particularly to a method, device, and system for radio resource configuration as well as UE power saving in a wireless network.

### BACKGROUND

With the rapid evolution of wireless communication technology, various applications, such as Extended Reality (XR), Ultrareliable and low-latency communications (URLLC), are implemented to enrich services provided to users. For better user experience, such applications require lower latency for data transmission. Efficient resource configuration is critical to reduce the latency in wireless network. UE power consumption is another critical factor to consider in wireless network.

### SUMMARY

This disclosure is directed to a method, device, and system for radio resource configuration as well as UE power saving in a wireless network.

In some embodiments, a method performed by a wireless device is disclosed. The method may include: initiating a random access procedure with a wireless communication node; receiving control information addressed to an identifier of the wireless device carrying scheduling information for reception of a message carrying contention resolution information, the scheduling information indicating a frequency domain resource allocated to the message, and the contention resolution information indicating whether a contention resolution associated with the random access procedure is successful; and in response to one of: the frequency domain resource allocated to the message being larger than a threshold; or the message being unable to be decoded successfully, performing at least one of: considering the contention resolution to be unsuccessful; consider this Random Access procedure unsuccessfully completed stopping a contention resolution timer associate with the random access procedure; discarding a temporary Cell Radio Network Temporary Identifier (C-RNTI) assigned by the wireless communication node for the random access procedure; or triggering another random access procedure.

In some embodiments, a method performed by a wireless device is disclosed. The method may include: receiving, from a wireless communication node, a message comprising Connected Mode Discontinuous Reception (C-DRX) configuration update information; and transmitting, to the wireless communication node, a confirmation message confirming that C-DRX configuration of the wireless device is updated according to the C-DRX configuration update information.

In some embodiments, a method performed by a wireless communication node is disclosed. The method may include: transmitting, to a wireless device, configuration information of a connected mode discontinuous reception (C-DRX), wherein the C-DRX applies to a service with a periodicity that is mis-aligned with a periodicity of the C-DRX.

In some embodiments, there is a wireless device or a wireless communication node comprising a processor and a memory, wherein the processor is configured to read code from the memory and implement any methods recited in any of the embodiments.

In some embodiments, a method performed by a wireless device is disclosed. The method may include: transmitting, to a wireless communication node, a message comprising: a Buffer Status Report (BSR) based on a BSR table selected from at least two BSR tables, and an indicator indicating at least one of: the BSR table selected; or whether delay information associated with the BSR is reported.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example wireless communication node (or wireless network node).

FIG. 3 shows an example user equipment.

FIGS. 4a and 4b show exemplary random access procedures.

FIGS. 5a-5e show an exemplary MAC subheaders for carrying Buffer Status Report (BSR) table selection indication and/or delaying information reporting indication.

FIGS. 6a-6b show exemplary C-DRX periodicity and on-duration configurations as well as associated XR periodicity.

FIG. 7a shows a flowchart of a C-DRX configuration update procedure using MAC CE.

FIG. 7b shows an example structure of a MAC CE carrying C-DRX configuration update parameters.

FIG. 7c shows a flowchart of a C-DRX configuration update procedure using DCI.

FIG. 8 shows a flowchart for an exemplary method for random access according to one of the embodiments.

### DETAILED DESCRIPTION

### Wireless Communication Network

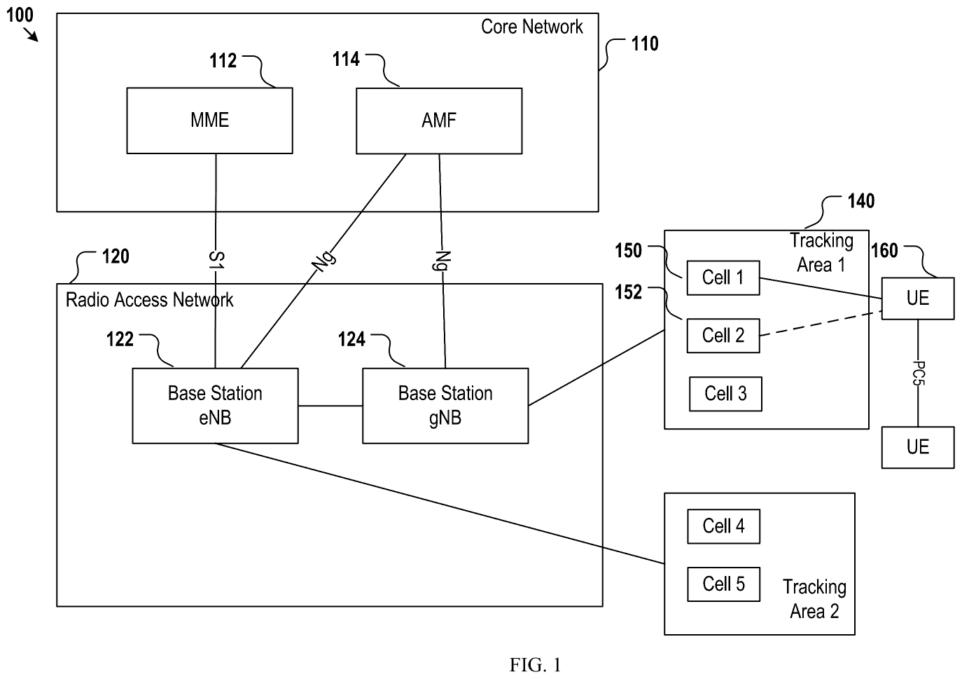

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, an enhanced LTE eNB (ng-eNB), or a Next generation NodeB (gNB) for 5G New Radio (NR), or any other type of signal transmitting/receiving device such as a UMTS NodeB. The eNB 122 communicates with the MME 112 via an SI interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may also be generally referred to as a wireless communication device, or a wireless terminal. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

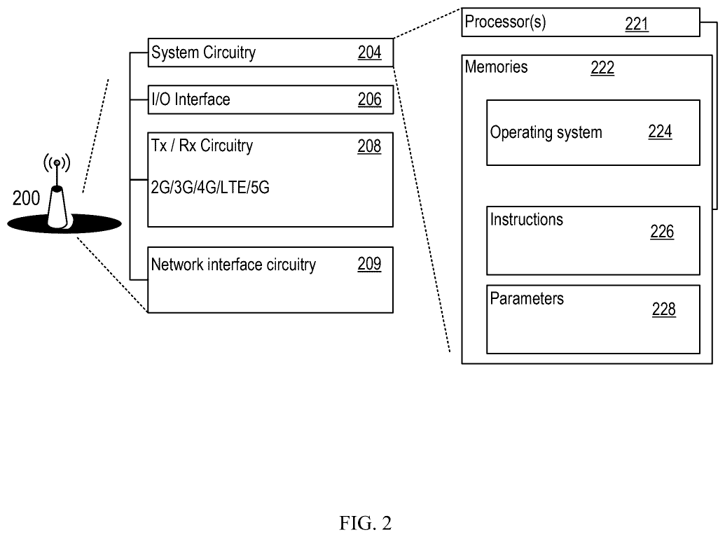

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

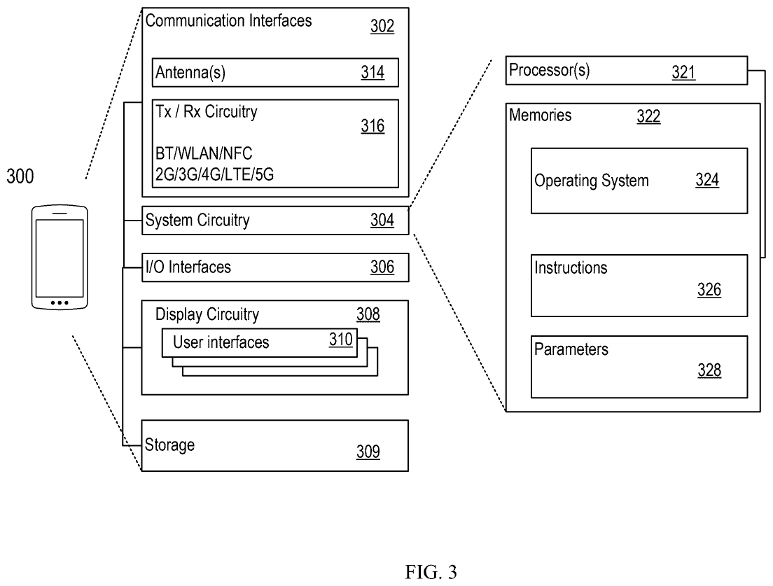

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

### Embodiment 1: Efficient Contention Resolution in 4 Step Random Access Procedure

In a mobile communication system (e.g., a 5G system, a 4G LTE system, a 3G UMTS system, etc.), the UE and the network need to establish a connection for the transmission of, for example, service data or application data.

In this disclosure, the network may include a Radio Access Network (RAN) which may further include one or more base stations. The network may further include a core network. A connection between the UE and the network may include, for example, a connection between the UE and a base station in the network, a connection between the UE and a cell in the network, etc.

In order to establish uplink synchronization and/or Radio Resource Control (RRC) connection, UE may need to perform a random access procedure, also known as RACH (Random Access Channel) procedure, or a PRACH (Physica RACH) procedure. There may exist different implementations for the RACH procedure, for example, 4-step Contention Based Random Access (CBRA) procedure, and 2-step CBRA procedure. There may also exist RACH procedures that are contention free.

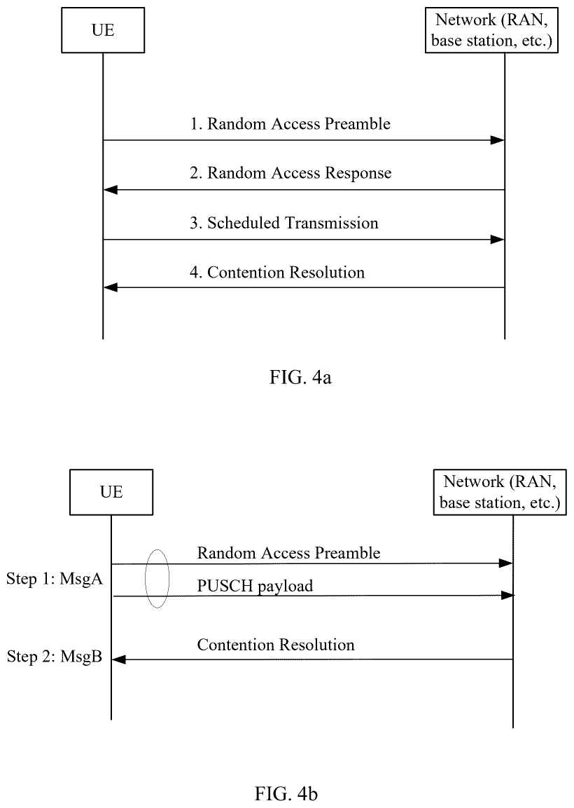

FIG. 4a shows an example 4-step CBRA procedure which includes follow steps:

### Step 1:

UE selects a preamble (or preamble resource) from available PRACH resource pool, and sends the selected preamble (e.g., in Msg1) to the network (e.g., a base station such as a gNB). Note that at same time, other UE(s) may also select the same preamble resource for a RACH procedure, which may lead to a contention.

### Step 2:

After reception of preamble, the base station sends back a random access response (RAR) (e.g., in Msg2) to the UE. The RAR may include a temporary Cell Radio Network Temporary Identifier (C-RNTI) allocated by the base station, and/or an Uplink (UL) grant.

### Step 3:

UE stores the temporary C-RNTI and sends to the base station a third message (e.g., Msg3) using the UL grant indicated in the RAR. Exemplarily, the Msg3 may be sent from RRC layer, in which case the Msg3 may also be referred to as an RRC Msg3. The Msg3 may carry an identity, such as a UE Contention Resolution Identity, for the purpose of contention resolution.

After sending Msg3, the UE may start a contention resolution timer (e.g., ra-ContentionResolutionTimer), and monitor the PDCCH.

### Step 4:

The base station may send the PDCCH addressed to the temporary C-RNTI (as described in steps 2 and 3, may be noted as TEMPORARY_C-RNTI) for Msg4 scheduling. The base station may assist the UE in contention resolution by using a C-RNTI on the PDCCH or using the UE Contention Resolution Identity (which the base station obtains based on the UL CCCH SDU (e.g., Msg3) received in previous step) on the PDSCH. The base station may send a Msg4 for contention resolution.

UE obtains the PDCCH addressed to its temporary C-RNTI. If the MAC PDU associated with the Msg4 contains a UE Contention Resolution Identity MAC CE, and the UE Contention Resolution Identity in the MAC CE matches the UL CCCH SDU (e.g., Msg3), the UE considers the Contention Resolution to be successful; otherwise if the UE Contention Resolution Identity does not match, the UE considers the Contention Resolution to be not successful, discards the TEMPORARY_C-RNTI and triggers the RACH procedure again.

If the ra-ContentionResolutionTimer expires before the UE is able to determine that the Contention Resolution is successful, the UE considers the Contention Resolution not successful, discards the TEMPORARY_C-RNTI and triggers the PRACH procedure again.

In a wireless system, an eRedCap UE (enhanced Reduced Capability UE) may use the random access procedure in order to access the wireless network. An eRedCap UE is designed with at least following considerations: capabilities (e.g., hardware and/or software), battery life, complexity, cost, etc. For example, an eRedCap UE may only be capable of handling limited bandwidth (or a partial bandwidth in a wireless sysmte), or an eRedCap UE may only be required to handle/process limited bandwidth. For example, the limited bandwidth may be defined by a threshold, such as 5 Mega Hertz (Mhz). The limited bandwidth may be defined by a number of Physical Resource Blocks (PRBs) under a certain Subcarrier Spacing (SCS), for example, 25 PRBs for 15 kHz SCS, or 12 PRBs for 30 KHz SCS.

In the above 4-step RACH procedure, an cRedCap UE and a legacy UE (e.g., a Reduced Capability UE (RedCap UE)) may use a same preamble in step 1. In this case, when the base station sends the RAR to UEs including the eRedCap UE and the legacy UE, the RAR will include a temporary C-RNTI. Upon receiving the RAR, both the legacy UE and the cRedCap UE will send an RRC Msg3 to the base station. Based on the LC ID associated the RRC Msg3, the base station may identify whether the UE is a legacy UE or an eRedCap UE. Even in case both UEs send an RRC Msg3, the base station may only detect one of them (either from eRedCap UE, or the legacy UE), and schedule the corresponding RRC Msg4 based on the UE Type. That is, the RRC Msg4 may only target one UE.

If the RRC Msg3 detected by the base station was sent by the legacy UE, the base station may schedule RRC Msg4 with more than 5 Mhz bandwidth (e.g., more than 25 PRBs under 15 kHz SCS (Subcarrier Spacing), or more than 12 PRBs under 30 kHz SCS), and the cRedCap UE may not decode it successfully due to the excessive bandwidth (note that the Msg4 does not target the eRedCap UE). Alternatively or additionally, the eRedCap UE may consider the downlink resource assignment for Msg4 is not valid due to the excessive bandwidth that is allocated, for example, when receiving PDCCH which is addressed to its TEMPORARY_C-RNTI. In this scenario, under current practice, the eRedCap UE will keep monitoring the PDCCH until the ra-ContentionResolutionTimer expires, although the base station will not schedule another RRC Msg4 (as the base station already scheduled one for the legacy UE). In this case, the eRedCap UE can only determine that the contention resolution is un-successful after the contention resolution timer expires. However, waiting till the contention resolution timer expires will only waste the UE power consumption and delay the RACH procedure.

In this embodiment, an improved 4-step RACH procedure is described. The eRedCap UE may detect the contention resolution failure more quickly, rather than wait till the contention resolution timer expires. In step 4 of the 4-step RACH procedure, when the eRedCap UE detects the PDCCH addressed to its TEMPORARY_C-RNTI, but the associated MAC PDU (e.g., MAC PDU contains contention resolution that is scheduled by the PDCCH) is not able to be successfully decoded due to the size of frequency domain resource allocated to Msg4 (or the MAC PDU) is larger than a predetermine threshold, the UE will consider the Contention Resolution to be not successful. Alternatively or additionally, the eRedCap UE may check the size of frequency domain resource allocated to Msg4 (or the MAC PDU) when it detects the PDCCH addressed to its TEMPORARY_C-RNTI before even attempting to decode Msg4/MAC PDU. If the size is larger than the predetermine threshold, then the eRedCap UE may determine that the Msg4 is not targeted to itself but rather another UE (e.g., a legacy UE) using a same preamble for random access. The eRedCap UE may therefore consider the Contention Resolution to be not successful and skip the effort to decode Msg4/MAC PDU. The threshold may include a maximum bandwidth that the eRedCap UE is required to handle, or a maximum bandwidth that the eRedCap UE is capable of handling. For example, the threshold may be 5 Mhz; 25 Physical Resouurce Blocks (PRBs) under 15 kHz SCS; or 12 PRBs under 30 kHz SCS.

After determining that the Contention Resolution is not successful, the eRedCap UE perform at least one of: stopping the contention resolution timer, discarding the TEMPORARY_C-RNTI; and triggering the RACH procedure again.

In this embodiment, when a Msg4 is allocated with more frequency resource than an eRedCap UE is required to or is able to handle, or when the MAC PDU associated with the Msg4 is not decoded successfully, the eRedCap UE determines that the contention resolution fails, and directly trigger another RACH procedure, rather than wait for the contention resolution timer expiring. The technical feature in this embodiment will help to save UE power and reduce the RACH procedure delay.

### Embodiment 2: Efficient Contention Resolution in 2-Step Random Access Procedure

This embodiment aims to solve the similar issue as discussed in embodiment 1, but focuses on 2-step RACH procedure.

FIG. 4b shows an example 2-step CBRA procedure which includes follow steps:

### Step 1:

UE sends MsgA to the network (e.g., a base station such as a gNB). The MsgA may include a Random Access Preamble, and a Physical Uplink Shared Channel (PUSCH) payload. The UE then starts a monitoring window, such as a msgB-ResponseWindow, to monitor the response from the base station within the monitoring window. Note that at same time, other UE(s) may also select the same preamble resource for a RACH procedure, which may lead to a contention.

In one implementation, the MsgA may carry a Common Control Channel Service Data Unit (CCCH SDU), which is indicative of a UE Contention Resolution Identity, or can be used to derive/generate the UE Contention Resolution Identity. The UE Contention Resolution Identity may be used for the purpose of contention resolution.

Based on a Random Access Preamble occasion that the UE selects, an MSGB-RNTI (MSGB Radio Network Temporary Identifier) associated with the PRACH occasion can be generated.

### Step 2:

The base station schedules the DL grant for MsgB by sending a PDCCH addressed to the MSGB-RNTI and then sends a MsgB to the UE. The MsgB may include a MAC PDU for Random Access Response (RAR), and/or a Contention Resolution Identity MAC subPDU. If the UE Contention Resolution Identity in the MAC subPDU matches the UE Contention Resolution Identity sent in MsgA (e.g., the CCCH SDU was included in the MSGA and the UE Contention Resolution Identity in the MAC subPDU matches the CCCH SDU), the UE stops the monitoring window, such as the msgB-Response Window, and considers this Random Access procedure successfully completed.

If the monitoring window expires, UE considers the Contention Resolution to be not successful, and may restart the RACH procedure and transmit MsgA again.

In the above 2-step RACH procedure, an eRedCap UE and a legacy UE (e.g., a Reduced Capability UE (RedCap UE)) may use a same preamble in step 1. Based on the LC ID associated the MsgA, the base station may identify whether the UE is a legacy UE or an eRedCap UE. Even in case both UEs send an MsgA, the base station may only detect one of them (either from eRedCap UE, or the legacy UE), and schedule the corresponding MsgB based on the UE Type.

If the MsgA detected by the base station was sent by the legacy UE, the base station may schedule a corresponding MsgB with more than 5 Mhz bandwidth (e.g., more than 25 PRBs under 15 kHz SCS, or more than 12 PRBs under 30 kHz SCS), and the eRedCap UE may not decode it successfully due to the excessive bandwidth (e.g., beyond eRedCap UE's capability). Alternatively or additionally, the eRedCap UE may consider the downlink resource assignment for MsgB is not valid due to the excessive bandwidth. In this scenario, under current practice, the eRedCap UE will keep monitoring the PDCCH until the monitoring window (e.g., msgB-Response Window) expires, although the base station will not schedule another MsgB (as the base station already scheduled one for the legacy UE). In this case, the cRedCap UE can only determine that the contention resolution is un-successful after the monitoring window expires. However, waiting till the monitoring window expires will only waste the UE power consumption and delay the RACH procedure.

In this embodiment, an improved 2-step RACH procedure is described. The eRedCap UE may detect the contention resolution failure more quickly. In step 2 of the 2-step RACH procedure, when the eRedCap UE detects the PDCCH addressed to itself (e.g., via an MsgB-RNTI assigned to the eRedCap), but the associated MAC PDU (e.g., MAC PDU contains contention resolution that is scheduled by the PDCCH) is not able to be successfully decoded due to the size of frequency domain resource allocated to MsgB (or the MAC PDU) is larger than a predetermine threshold, the UE will consider the Contention Resolution to be not successful. Alternatively or additionally, the eRedCap UE may check the size of frequency domain resource allocated to MsgB (or the MAC PDU) (e.g., when UE detects the PDCCH addressed to its MsgB-RNTI) before even attempting to decode the MAC PDU. If the size is larger than the predetermine threshold, then the eRedCap UE may determine that the MsgB is not targeted to itself but rather a legacy UE using a same preamble. The eRedCap UE may therefore consider the Contention Resolution to be not successful and skip the effort to decode the MAC PDU. The threshold may include as a maximum bandwidth that the eRedCap UE is required to handle, or a maximum bandwidth that the eRedCap UE is capable of handling. For example, the threshold may be 5 Mhz; 25 PRBs under 15 kHz SCS; or 12 PRBs under 30 kHz SCS.

After determining that the Contention Resolution is not successful, the eRedCap UE perform at least one of: stopping the monitoring window (e.g., msgB-ResponseWindow), consider this Random Access procedure unsuccessfully completed and triggering the RACH procedure again (e.g. perform the same procedure as that when the monitoring widow expires).

In this embodiment, when a MsgB is allocated with more frequency resource than an eRedCap UE can handle, or when the MAC PDU associated with the MsgB is not decoded successfully, the eRedCap UE determines that the contention resolution fails, and directly trigger another RACH procedure, rather than wait for the monitoring window expiring. The technical feature in this embodiment will help to save UE power and reduce the RACH procedure delay.

### Embodiment 3-BSR Table and Delay Reporting Identification

In some example implementations, to support certain services including but not limited to extended Reality (XR) service in a wireless system, such as an NR system, more than one Buffer Status Report (BSR) table may be used in order to gain finer granularity on buffer status (such as buffer size) reporting. Meanwhile, delay information associated with the BSR may also be reported.

In some example implementations, the delay information identifies one or more of: a first time duration from a first occasion a packet arrived in the buffer to a second occasion in which the delay report of buffered data was transmitted, a second time duration from the first occasion a packet arrived in the buffer to a third occasion that is indicated by a reference time, a first remaining time duration from the second occasion in which the delay report of buffered data was transmitted to the base station to a third occasion that an access network packet delay budget (AN PDB) is reached, a second remaining time duration from a fourth occasion that is indicated by the reference time to the third occasion that an AN PDB is reached, a third time duration from the second occasion the delay report of buffered data was transmitted to an expiration time of a packet discard timer, or a fourth time duration from the fourth occasion that is indicated by the reference time to the expiration time of the packet discard timer.

The buffer status report may employ a Medium Access Control (MAC) procedure and may be sent via a MAC Control Element (MAC CE), such as a BSR MAC CE. When the system supports more than one BSR table, and/or delay information reporting, identification information is needed to indicate which BSR table is used, and/or whether delay information is reported.

In some example implementations, the BSR table may be selected from multiple (e.g., >=2) BSR tables, based on at least one of: a type of a service associated with the BSR (e.g., XR service, Enhanced mobile broadband (eMBB), Ultra-reliable and low-latency communications (URLLC)); or a granularity requirement of the BSR.

In some example implementations, the Logical Channel Identifier (LC ID) in the BSR MAC CE may be used to carry the above-mentioned identification information. Note that the LC ID may be shared by other functionalities, and only limited number of LC IDs may be used for BSR table indication and/or delay information reporting.

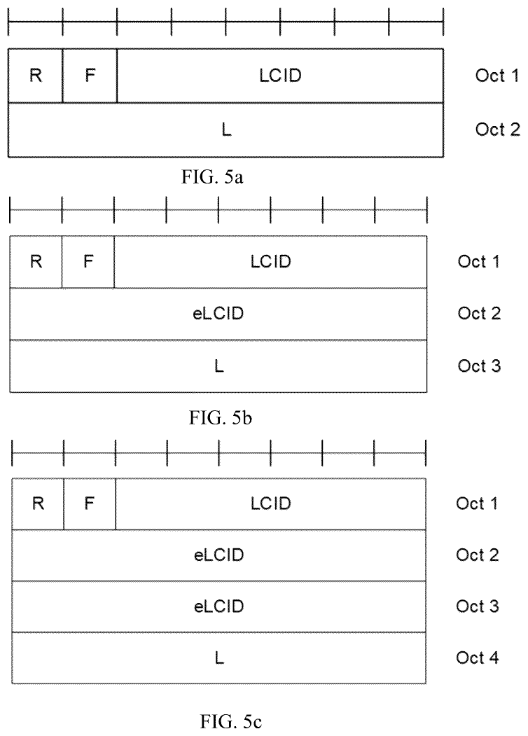

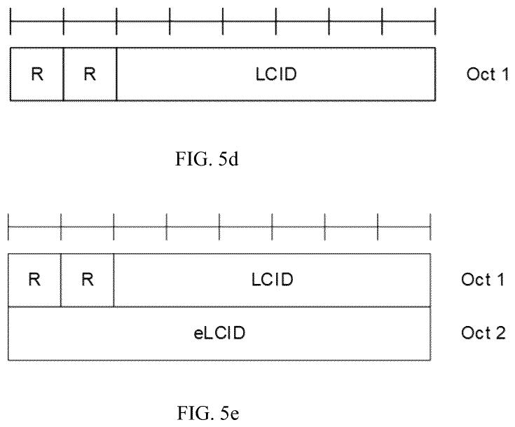

Note that each BSR MAC CE may correspond to a MAC subheader. FIGS. 5a-5c show various example the MAC subheaders, with each subheader having one reserved bit (marked by “R”). FIGS. 5d-5e show various example the MAC subheaders, with each subheader having two reserved bits (marked by “R”). In some example implementations, the reserved bit(s) in the MAC CE subheader may be used to indicate which BSR table is used, and/or whether delay information is reported. Some examples on how to use the reserved bit(s) to make the indication are described below. Unless specifically mentioned, the MAC CE is for BSR related reporting, which may be indicated by LC-ID.

### Example 1

Two BSR tables are supported. Note that the first BSR table may exist in current technology so the first BSR table is a legacy BSR table, and one new BSR table is added in this embodiment.

In FIGS. 5a-5c, the bit in the “R” field indicates which BSR table is used for BSR reporting. For example, a bit “0” indicates that the first BSR table is used, and a bit “1” indicates that the second BSR table is used.

### Example 2

In FIGS. 5a-5c, the bit in the “R” field indicates whether delay information associated with the BSR is reported. For example, a bit “0” indicates that delay information is not reported, and a bit “1” indicates that the delay information is reported.

### Example 3

Four BSR tables are supported. Note that the first BSR table may exist in current technology so the first BSR table is a legacy BSR table, and 3 new BSR tables are added in this embodiment.

In FIGS. 5d-5e, the two bits in the two “R” fields indicate which BSR table is used for BSR reporting. For example, when the two bits are set to “00”, it indicates that the first BSR table is used for BSR reporting; when the two bits are set to “01”, it indicates that the second BSR table is used for BSR reporting; when the two bits are set to “10”, it indicates that the third BSR table is used for BSR reporting; when the two bits are set to “11”, it indicates that the fourth BSR table is used for BSR reporting

### Example 4

Two BSR tables are supported. Note that the first BSR table may exist in current technology so the first BSR table is a legacy BSR table, and one new BSR table is added in this embodiment.

In FIGS. 5d-5e, one bit in one “R” field may be used to indicate which BSR table is used for BSR reporting, and another bit in the other “R” field may be used to indicate delay information associated with the BSR is reported. For example, when the two “R” field is set to “01”, it indicates that the first BSR table (i.e., the legacy BSR table) is used for BSR reporting and the delay information is reported associated with the BSR; when the two “R” field is set to “10”, it indicates that the second BSR table is used in for BSR reporting and the delay information is not reported; when the two “R” field is set to “11”, it indicates that the second BSR table is used for BSR reporting and the delay information is reported associated with the BSR.

### Embodiment 4: C-DRX on-duration Start Occasion Determination

In some embodiments, the C-DRX (Connected mode Discontinuous Reception) on-duration start occasion may be determined based on periodicity of a service/application, for example, an XR service. In following discussion, XR service is used merely as an example, and the embodiments apply to any suitable services. Specifically, the XR periodicity may be a non-integer multiple (or a fraction multiple) of the time unit used by the C-DRX periodicity (or time unit granularity of the C-DRX periodicity, or minimal time unit used for the C-DRX periodicity). For example, if the C-DRX periodicity is in the granularity of millisecond (ms), then an XR periodicity of 16.667 ms is counted as 16.667 times of the time unit granularity of the C-DRX periodicity. The time unit granularity may be presented by other time units, including but not limited to: frame, sub frame, slot, mini slot, or symbol (e.g., OFDM symbol), as used in a wireless system such as 5G NR or 4G LTE. For example, when XR frame rate is 60 fps (frame per second), then the periodicity will be 50/3 ms or 16.667 ms.

In some example implementations, the C-DRX on-duration start occasion can be determined using one of following granularities (or time units): frame, sub frame, slot, mini slot, or symbol (e.g., OFDM symbol) granularity.

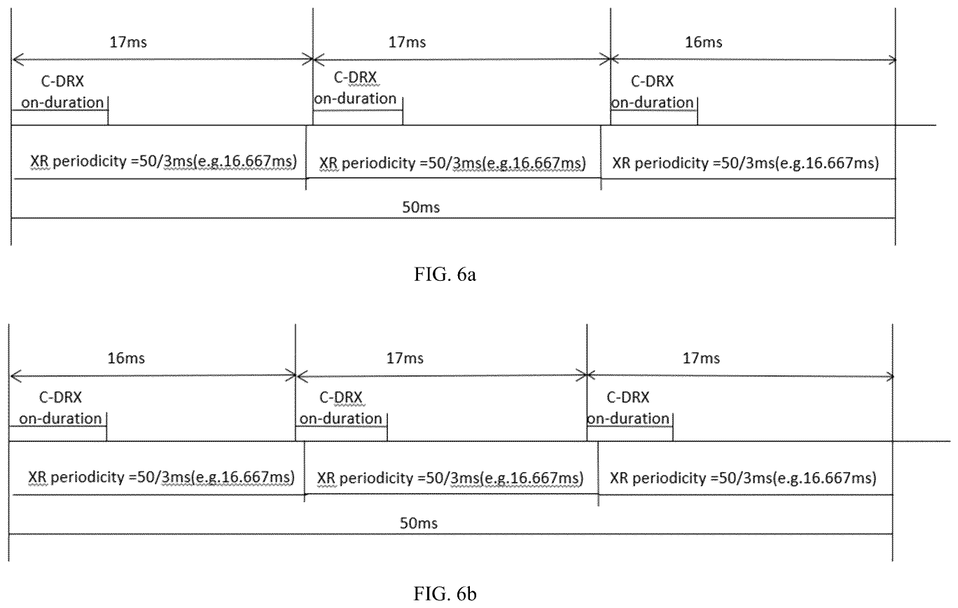

In some example implementations, the C-DRX on-duration may be started (immediately) after the data burst (e.g., for XR service) arrives at gNB (for DL transmission) and/or UE (for UL transmission), as shown in FIG. 6a. These types of implementations increase data transmission delay due to the late start of the C-DRX on-duration.

As shown in FIG. 6a, the XR data burst arrives at 60 fps (e.g., 50/3 ms, approximately 16.667 ms), but the C-DRX on-duration can only be started at the sub-frame boundary (e.g., Ims boundary). For UE power saving purpose, when the XR data burst arrives at a non-integer ms occasion, the C-DRX on-duration may start at the latest ms after the data burst arrives (e.g., the least integer ms that is larger than or equal to the non-integer ms). For example, if the data burst arrives at a 16.667 ms, then the C-DRX on-duration starts at 17 ms; if the data burst arrives at 33.333 ms, then the C-DRX on-duration starts at 34 ms; if the data burst arrives at 50 ms, then the C-DRX on-duration starts at 50 ms.

In order to reduce transmission delay, in some other example implementations, the C-DRX on-duration may start (immediately) before the data burst arrives at gNB (for DL) and/or UE (for UL), as shown in FIG. 6b.

In FIG. 6b, the XR data burst arrives at 60 fps (e.g., 50/3 ms, approximately 16.667 ms), but the C-DRX on-duration can only be started at the sub-frame boundary (e.g., 1 ms boundary). To balance the UE power saving and data scheduling latency, when the XR data burst arrives at a non-integer time occasion in millisecond, the C-DRX on-duration may start at the latest millisecond before the data burst arrives (e.g., the largest integer ms that is smaller than or equal to the non-integer ms). For example, if the data burst arrives at 16.667 ms, then the C-DRX on-duration starts at 16 ms; if the data burst arrives at 33.333 ms, then the C-DRX on-duration starts at 33 ms; if the data burst arrives at 50 ms, then the C-DRX on-duration starts at 50 ms).

In this disclosure, for a service having a periodicity that is a non-integer multiple (or a fraction multiple) of the time unit used by the C-DRX periodicity, the periodicity of the service may be referred to as a mis-aligned periodicity. For example, for an XR service with a 16.667 ms periodicity, the periodicity may be referred to as a mis-aligned XR periodicity.

In following example embodiments, drx-periodicity refers to the periodicity of a periodic service or a quasi-periodic service, such as an XR service. The drx-periodicity may be mis-aligned with the C-DRX periodicity. Note that drx-periodicity may be considered as an “ideal periodicity” of the C-DRX (to match the periodic service or the quasi-periodic service). As an example, as shown in FIG. 6a, the periodicity of the XR service is 16.667 ms, this is the drx-periodicity and is considered to be the “ideal periodicity” of the C-DRX. Although the real periodicity of the C-DRX has to be rounded according to the granularity of the time unit (e.g., at ms level in this case).

As discussed earlier, the mis-alignment of the service periodicity and the C-DRX periodicity may introduce delay to the service. For example, due to the mis-alignment, the service periodicity may start first (when there is data needs to be transmitted), however, the on-duration in a C-DRX cycle may not have started yet. Therefore, service data has to be buffered to be served at a later time when the next on-duration starts.

In this disclosure, various embodiments are described, aiming to determine an optimal C-DRX configuration, including C-DRX on-duration start occasion (e.g., when the on-duration should start), that is able to minimize data transmission latency, and meet Quality of Service requirement for services such as XR service, when the service periodicity and the C-DRX periodicity are mis-aligned. For example, the C-DRX on-duration may be started right before the XR service data arrival. That is, the C-DRX on-duration may be started at the latest boundary which is before the XR service data arrival.

In an embodiment, the SFN and Subframe number of a C-DRX on-duration start occasion may be determined by:

$$ceil ( [ ( ( 1024 \times m + SFN ) \times 10 ) + subframe\_number ] modulo ( drx - periodicity ) ) = ceil ( [ ( ( {SFN}_{start time} ) \times 10 ) + {subframe}_{start time} ] modulo ( drx - periodicity ) ) , \qquad ( EQ 1 - 1 )$$

where m=0 when the C-DRX is activated and is incremented (e.g., by 1) every time when SFN=0 (e.g., when SFN wrap around happens); SFN is the SFN of the C-DRX on duration start occasion, subframe_number is the subframe number of the C-DRX on duration start occasion, SFN_{start time} and subframeₛₜₐᵣₜ time are respectively the SFN and subframe of the first (1^{st} in order)C-DRX on-duration start occasion; and drx-periodicity is the mis-aligned periodicity of a periodic service or a quasi-periodic service, such as an XR service.

In one implementation, the SFN_{start time} and subframeₛₜₐᵣₜ time are indicated explicitly when/if the C-DRX is activated.

In an embodiment, the SFN and subframe number/index of a C-DRX on-duration start occasion may be determined by:

$$ceil ( [ ( ( 1024 \times m + SFN ) \times 10 ) + subframe\_number ] modulo ( drx - periodicity ) ) = ceil ( [ ( ( timeReferenceSFN ) \times 10 ) + timeDomainOffset ] modulo ( drx - periodicity ) ) , \qquad ( EQ 1 - 2 )$$

where m=0 when the C-DRX is activated and is incremented every time SFN=0, SFN is the SFN of the C-DRX on-duration start occasion, subframe_number is the subframe number of the C-DRX on-duration start occasion, drx-periodicity is the mis-aligned periodicity of a periodic service or a quasi-periodic service, such as an XR service, and timeReferenceSFN and timeDomainOffset are indicated in the configuration information of the C-DRX and/or are used to determine the 1st C-DRX on-duration start occasion.

In an embodiment, the SFN and subframe number of a C-DRX on-duration start occasion can be determined by:

$$ceil ( [ ( ( 1024 \times m + SFN ) \times 10 ) + subframe\_number ] modulo ( drx - periodicity ) ) = drx - StartOffset , \qquad ( EQ 1 - 3 )$$

where m=0 when C-DRX is activated and is incremented every time SFN=0, SFN is the SFN of the C-DRX on-duration start occasion, subframe_number is the subframe number of the C-DRX on-duration start occasion, drx-StartOffset is indicated explicitly when the C-DRX is activated which is used to determine the SFN and Subframe of the C-DRX on-duration start occasion; and drx-periodicity is the mis-aligned periodicity of a periodic service or a quasi-periodic service, such as an XR service.

In an embodiment, the SFN and a slot number of a C-DRX on-duration start occasion can be determined by:

$$ceil ( [ ( ( 1024 \times m + SFN ) \times 10 ) + numberOfSlotsPerFrame ) + slot\_number ] modulo ( ( drx - periodicity ) \times numberOfSlotsPerFrame \div 10 ) ) = ceil ( [ \text{} ( ( {SFN}_{start time} ) \times numberOfSlotsPerFrame \times 10 ) + {slot}_{start time} ] modulo ( ( drx - periodicity ) \times numberOfSlotsPerFrame \div 10 ) ) , \qquad ( EQ 1 - 4 )$$

where m=0 when the C-DRX is activated and is incremented every time SFN=0; SFN is the SFN of the C-DRX on-duration start occasion, slot_number is the slot number of the C-DRX on-duration start occasion, SFN_{start time} and slot_{start time} are respectively the SFN and the slot number of the first (1st)C-DRX on-duration start occasion where the C-DRX is (re-) configured or activated; and drx-periodicity is the mis-aligned periodicity of a periodic service or a quasi-periodic service, such as an XR service. In this embodiment, the SEN_{start time} and slot_{start time} may be explicitly indicated (e.g., by the network or base station) if the C-DRX is (re-) configured or activated or (re-) configured.

In an embodiment, the SFN, slot number and symbol number of a C-DRX on-duration start occasion can be determined by:

$$ceil ( [ ( ( 1024 \times m + SFN ) \times numberOfSlotsPerFrame \times numberOfSymbolsPerSlot ) + ( slot\_number \times numberOfSymbolsPerSlot ) + symbol\_number ] modulo ( ( drx - periodicity ) \times numberOfSlotsPerFrame \times numberOfSymbolsPerSlot \div 10 ) ) = ceil ( [ ( ( {SFN}_{start time} ) \times numberOfSlotsPerFrame \times numberOfSymbolsPerSlot ) + ( {slot}_{start time} \times numberOfSymbolsPerSlot ) + {symbol}_{start time} ] modulo ( ( drx - periodicity ) \times numberOfSlotsPerFrame \times numberOfSymbolsPerSlot \div 10 ) ) , \qquad ( EQ 1 - 5 )$$

where m=0 when the C-DRX is activated and is incremented every time SFN=0; SFN is the SFN of the C-DRX on-duration start occasion, slot_number is the slot number of the C-DRX on-duration start occasion, symbol_number is the symbol number of the C-DRX on-duration start occasion, SFN_{start time}, slot_{start time} and symbol_{start time} are respectively the SFN, slot number and symbol number of the first (1st)C-DRX on-duration start occasion; and drx-periodicity is the mis-aligned periodicity of a periodic service or a quasi-periodic service, such as an XR service. In this embodiment, the SFN_{start time}, slot_{start time} and symbolₛₜₐᵣₜₜᵢₘₑ may be explicitly indicated when/if the C-DRX is activated or (re-) configured.

In an embodiment, the SFN and the subframe number of the C-DRX on-duration start occasion can be determined by:

$$[ ( SFN \times 10 ) + subframe\_number ] = floor ( [ ( timeReferenceSFN ) \times 10 - timeDomainOffset + N \times ( drx - periodicity ) ] modulo ( 10240 ) ) , \qquad ( EQ 1 - 6 )$$

where SFN is the SFN of the C-DRX on-duration start occasion, subframe_number is the subframe number of the C-DRX on-duration start occasion, timeReferenceSFN and timeDomainOffset are used to indicate the first (1st)C-DRX on duration start occasion; drx-periodicity is the mis-aligned periodicity of a periodic service or a quasi-periodic service, such as an XR service; and N is an integer greater than or equal to 0.

In an embodiment, the SFN and the subframe number of the C-DRX on-duration start occasion can be determined by:

$$[ ( SFN \times 10 ) + subframe\_number ] = floor ( [ {SFN}_{starttime} \times 10 + {subframe}_{starttime} + N \times ( drx - periodicity ) ] modulo ( 10240 ) ) , \qquad ( EQ 1 - 7 )$$

where SFN_{start time} and subframeₛₜₐᵣₜ time are respectively the SFN and subframe number of the first (1st)C-DRX on-duration start occasion; drx-periodicity is the mis-aligned periodicity of a periodic service or a quasi-periodic service, such as an XR service; and N is an integer greater than or equal to 0. In an embodiment, the SFN_{start time} and subframeₛₜₐᵣₜ time are indicated explicitly when/if the C-DRX is activated.

In an embodiment, the SFN and the slot number of the C-DRX on-duration start occasion can be determined by:

$$[ ( SFN \times numberOfSlotsPerFrame ) + slot\_number ] = floor ( [ {SFN}_{starttime} \times numberOfSlotsPerFrame + {slot}_{starttime} + N \times ( drx - periodicity ) ] modulo ( 1024 \times numberOfSlotsPerFrame ) ) , \qquad ( EQ 1 - 8 )$$

where SFN is the SFN of the C-DRX on-duration start occasion, slot_number is the slot number of the C-DRX on-duration start occasion, where SFN_{start time} and subframeₛₜₐᵣₜ time are respectively the SFN and subframe number of the first (1st)C-DRX on-duration start occasion; drx-periodicity is the mis-aligned periodicity of a periodic service or a quasi-periodic service, such as an XR service; and N is an integer greater than or equal to 0.

In an embodiment, the SFN and the subframe number of the C-DRX on-duration start occasion can be determined by:

$$[ SFN \times numberOfSlotsPerFrame \times numberOfSymbolsPerSlot + slot\_number \times numberOfSymbolsPerSlot + Symbol number ] = floor ( [ {SFN}_{starttime} \times numberOfSlotsPerFrame \times numberOfSymbolsPerSlot + {slot}_{starttime} \times numberOfSymbolsPerSlot + {Symbol}_{starttime} + N \times ( drx - periodicity ) ] modulo ( 1024 \times numberOfSlotsPerFrame \times numberOfSymbolsPerSlot ) ) , \qquad ( EQ 1 - 9 )$$

where SFN_{start time}, subframeₛₜₐᵣₜ time, and Symbolₛₜₐᵣₜₜᵢₘₑ are respectively the SFN, subframe, Symbol number of the first (1st)C-DRX on-duration start occasion; drx-periodicity is the mis-aligned periodicity of a periodic service or a quasi-periodic service, such as an XR service; and N is an integer greater than or equal to 0. In an embodiment, the SFN_{start time} and subframeₛₜₐᵣₜ time are indicated explicitly when/if the C-DRX is activated. SFN_{start time}, subframe_{start time} and/or Symbolₛₜₐᵣₜₜᵢₘₑ can also be indicated by timeReferenceSFN and timeDomainOffset.

Note that in the formula above, the ceil (x) operation can also be substitute by floor (x) operation or round (x) operation; and the floor (x) operation can also be substitute by ceil (x) operation or round (x) operation. Where the ceil (x) operation is used to obtain the least integer that is larger than or equal to the value x; the floor (x) operation is used to obtain the largest integer that is less than or equal to the value x, and the round (x) is used to obtain the integer that is nearest to value x.

### Embodiment 5

For XR with mis-aligned periodicity, C-DRX may be used for UE power saving. The C-DRX configuration may be dynamically adjusted to match the XR service data rate (e.g., cadence change), and/or XR data burst arrival time. The C-DRX configuration may include, for example, C-DRX periodicity, C-DRX start time, C-DRX start offset, etc.

In some implementations, the C-DRX configuration may be updated by RRC message(s) (e.g., by using a RRCReconfiguration procedure). However, the cost of using the RRC message(s) is high with regard to radio resource usage and UE power consumption, which gets even worse if C-DRX configuration need to be updated frequently.

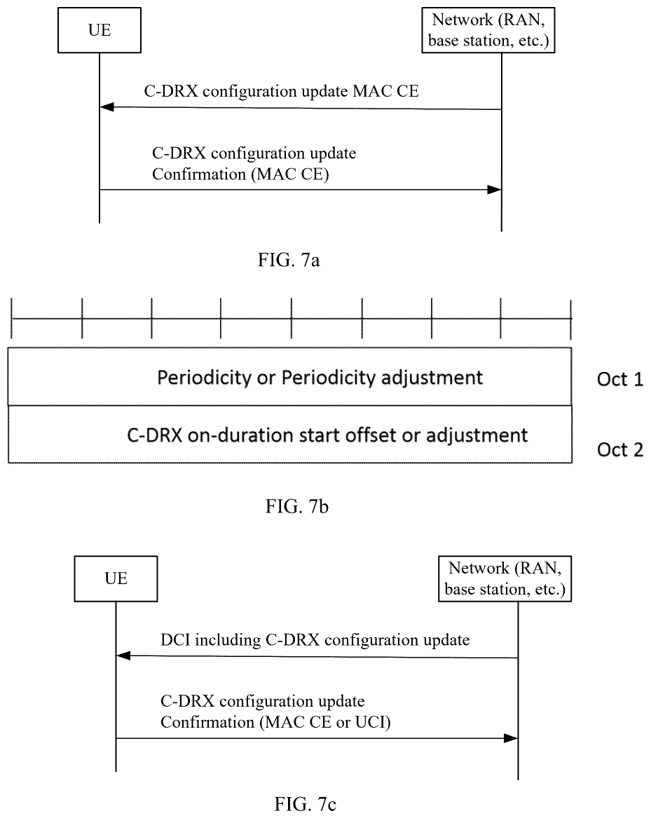

In this embodiment, to update C-DRX configuration more efficiently, MAC CE or DCI (Downlink Control Information) can be used. For example, the C-DRX configuration update information may be included in MAC CE or DCI (As shown in FIGS. 7a and 7b), and send to UE. The discussion below uses gNB as an example base station, but the embodiments also apply to other types of base stations, such as eNB, ng-eNB, NodeB, etc.

Where the C-DRX configuration update information includes at least one of the following:
C-DRX periodicity;
C-DRX periodicity adjustment amount (or scale factor) (e.g., the new C-DRX periodicity=the current C-DRX periodicity+C-DRX periodicity adjustment amount; or the new C-DRX periodicity=the current C-DRX periodicity * DRX periodicity adjustment amount);
C-DRX on-duration start time (e.g., SFN, slot);
C-DRX on-duration start time offset;
C-DRX on-duration start time adjustment amount (e.g., the new C-DRX on-duration start time=the current C-DRX on-duration start time+C-DRX on-duration start time adjustment amount); and
C-DRX on-duration start time offset adjustment amount (e.g., the new C-DRX on-duration start time offset=the current C-DRX on-duration start time offset+C-DRX on-duration start time offset adjustment amount).

When UE receives the MAC CE to update the C-DRX configuration (e.g., the C-DRX configuration update information is included in MAC CE), the UE sends the C-DRX configuration update Confirmation MAC CE to gNB to align the behavior between UE and gNB.

When UE receives the DCI to update the C-DRX configuration (e.g., the C-DRX configuration update information is included in DCI), the UE sends the C-DRX configuration update Confirmation MAC CE or a UCI (Uplink Control Information) to gNB to align the behavior between UE and gNB.

In example implementations, C-DRX configuration update Confirmation MAC CE may be a fixed size of zero bit (e.g., only a MAC subheader with specified LC ID is used to confirm the C-DRX configuration update).

After the UE receives the MAC CE or DCI used to update the C-DRX configuration, or before the UE sends the C-DRX configuration update Confirmation MAC CE or UCI (As shown in FIGS. 7a and 7c), the new C-DRX parameters will be applied to determine the C-DRX on-duration start occasion.

FIG. 7b shows a C-DRX configuration update MAC CE, in which C-DRX configuration update information are included. The number of bits that each field uses is for exemplary purpose only, and other number of bits may also be used.

Note that the described features, advantages and characteristics of the present solution may be combined in any suitable manner in one or more embodiments. For example, embodiment 5 may be combined with embodiment 4.

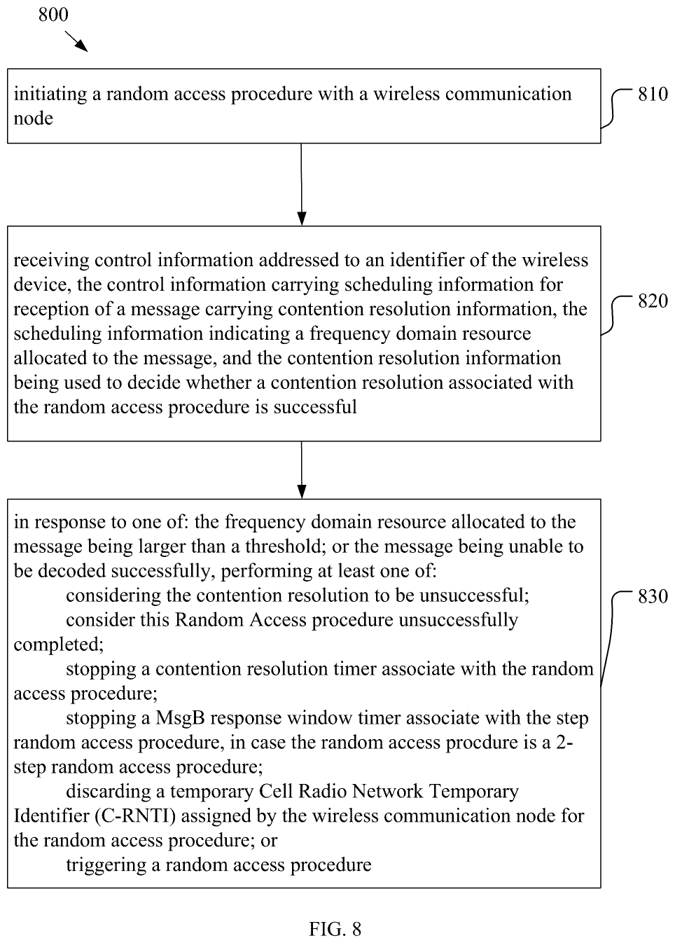

FIG. 8 shows an exemplary method 800 for wireless communication. The method may include a portion or all of the following step: step 800, initiating a random access procedure with a wireless communication node; step 810, receiving control information addressed to an identifier of the wireless device, the control information carrying scheduling information for reception of a message carrying contention resolution information, the scheduling information indicating a frequency domain resource allocated to the message, and the contention resolution information being used to decide (or indicating) whether a contention resolution associated with the random access procedure is successful; and step 820, in response to one of: the frequency domain resource allocated to the message being larger than a threshold; or the message being unable to be decoded successfully, performing at least one of: considering the contention resolution to be unsuccessful; consider this Random Access procedure unsuccessfully completed; stopping a contention resolution timer associate with the 4 step random access procedure; stopping a MsgB response window timer associate with the 2 step random access procedure; discarding a temporary C-RNTI assigned by the wireless communication node for the 4 step random access procedure; or triggering another random access procedure.

The exemplary method 800 may further include: wherein the wireless device is an enhanced Reduced Capability (eRedCap) User Equipment (UE) that is not required to or is not able to process a frequency bandwidth that is more than the threshold.

The exemplary method 800 may further include: wherein the control information is carried in a Physical Downlink Control Channel (PDCCH), and wherein the identifier is a Radio Network Temporary Identifier (RNTI) of the wireless device.

Exemplarily, the second message may be used for the setting up or the resuming of the connection. For example, the second message may confirm or acknowledge the connection setup request or the connection resume request. The second message may further carry configuration information that may be used for the connection setup or resume.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

In this disclosure, multiple messages may be combined as a single message, and a single message may be split into multiple messages, so long as they carry the same content and/or serving the same purpose. For example, as described earlier, a message carrying configuration information may be combined with a message indicating the enablement of the simplified UE network connection process. For another example, the connection request message and/or the connect request response message may also carry configuration information that network node or the UE needs to pass to the other end.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method for wireless communication, performed by a wireless device, comprising:
initiating a random access procedure with a wireless communication node;
receiving control information addressed to an identifier of the wireless device, wherein the control information carries scheduling information for reception of a message carrying contention resolution information, the scheduling information indicating a frequency domain resource allocated to the message, and the contention resolution information being used to decide whether a contention resolution associated with the random access procedure is successful; and
in response to the frequency domain resource allocated to the message being larger than a threshold:
considering the contention resolution to be unsuccessful;
stopping a contention resolution timer associate with the random access procedure; and
discarding a temporary Cell Radio Network Temporary Identifier (C-RNTI) assigned by the wireless communication node for the 4-step random access procedure.

2. The method of claim 1, wherein the wireless device is an enhanced Reduced Capability (eRedCap) User Equipment (UE) that is not able to process a frequency bandwidth that is more than the threshold.

3. (canceled)

4. The method of claim 1, wherein the random access procedure is contention based, and wherein before receiving the scheduling information, the method further comprises:
transmitting, to the wireless communication node, a random access preamble that is shared with at least one other wireless device.

5. The method of claim 1, wherein the control information is carried in a Physical Downlink Control Channel (PDCCH), and wherein the identifier is a Radio Network Temporary Identifier (RNTI) of the wireless device.

6. The method of claim 1, wherein:
the random access procedure is a 4-step contention based random access procedure;
the message is a Msg4 in the random access procedure;
the identifier of the wireless device is a TEMPORARY_C-RNTI; and
the contention resolution information is carried in a Medium Access Control (MAC) Protocol Data Unit (PDU).

7-21. (canceled)

22. The method of claim 1, further comprising considering the random access procedure to be unsuccessful.

23. The method of claim 1, further comprising triggering another random access procedure.

24. A wireless device comprising a memory for storing computer instructions and a processor in communication with the memory, wherein, when the processor executes the computer instructions, the processor is configured to cause the wireless device to:
initiate a random access procedure with a wireless communication node;
receive control information addressed to an identifier of the wireless device, wherein the control information carries scheduling information for reception of a message carrying contention resolution information, the scheduling information indicating a frequency domain resource allocated to the message, and the contention resolution information being used to decide whether a contention resolution associated with the random access procedure is successful; and
in response the frequency domain resource allocated to the message being larger than a threshold:
considering the contention resolution to be unsuccessful;
stopping a contention resolution timer associate with the random access procedure; and
discarding a temporary Cell Radio Network Temporary Identifier (C-RNTI) assigned by the wireless communication node for the 4-step random access procedure.

25. The wireless device of claim 24, wherein the wireless device is an enhanced Reduced Capability (eRedCap) User Equipment (UE) that is not able to process a frequency bandwidth that is more than the threshold.

26. The wireless device of claim 24, wherein the random access procedure is contention based, and wherein, before the processor is configured to cause the device to receive the scheduling information, the processor is configured to further cause the wireless device to:
transmit, to the wireless communication node, a random access preamble that is shared with at least one other wireless device.

27. The wireless device of claim 24, wherein the control information is carried in a Physical Downlink Control Channel (PDCCH), and wherein the identifier is a Radio Network Temporary Identifier (RNTI) of the wireless device.

28. The wireless device of claim 24, wherein:
the random access procedure is a 4-step contention based random access procedure;
the message is a Msg4 in the random access procedure;
the identifier of the wireless device is a TEMPORARY_C-RNTI; and
the contention resolution information is carried in a Medium Access Control (MAC) Protocol Data Unit (PDU).

29. The wireless device of claim 24, wherein, when the processor executes the computer instructions, the processor is configured to further cause the wireless device to consider the random access procedure to be unsuccessful.

30. The wireless device of claim 24, wherein, when the processor executes the computer instructions, the processor is configured to further cause the wireless device to trigger another random access procedure.

31. A non-transitory storage medium for storing computer readable instructions, the computer readable instructions, when executed by a processor in a wireless device, causing the processor to:
initiate a random access procedure with a wireless communication node;
receive control information addressed to an identifier of the wireless device, wherein the control information carries scheduling information for reception of a message carrying contention resolution information, the scheduling information indicating a frequency domain resource allocated to the message, and the contention resolution information being used to decide whether a contention resolution associated with the random access procedure is successful; and
in response the frequency domain resource allocated to the message being larger than a threshold:
considering the contention resolution to be unsuccessful;
stopping a contention resolution timer associate with the random access procedure; and
discarding a temporary Cell Radio Network Temporary Identifier (C-RNTI) assigned by the wireless communication node for the 4-step random access procedure.

32. The non-transitory storage medium of claim 31, wherein the wireless device is an enhanced Reduced Capability (eRedCap) User Equipment (UE) that is not able to process a frequency bandwidth that is more than the threshold.

33. The non-transitory storage medium of claim 31, wherein the random access procedure is contention based, and wherein, before the non-transitory storage medium cause the processor to receive the scheduling information, the non-transitory storage medium further cause the processor to:
transmit, to the wireless communication node, a random access preamble that is shared with at least one other wireless device.

34. The non-transitory storage medium of claim 31, wherein the control information is carried in a Physical Downlink Control Channel (PDCCH), and wherein the identifier is a Radio Network Temporary Identifier (RNTI) of the wireless device.

35. The non-transitory storage medium of claim 31, wherein:
the random access procedure is a 4-step contention based random access procedure;
the message is a Msg4 in the random access procedure;
the identifier of the wireless device is the TEMPORARY_C-RNTI; and
the contention resolution information is carried in a Medium Access Control (MAC) Protocol Data Unit (PDU).

36. The non-transitory storage medium of claim 31, wherein, the computer readable instructions further cause the processor to:
consider the random access procedure to be unsuccessful; and
trigger another random access procedure.
